(19) United States
(12) Patent Application Publication
(10) Pub. No.: US 2021/0349549 A1
(43) Pub. Date: Nov. 11, 2021

(54) NOISE-CANCELLING KEYBOARD

(71) Applicant: Yung-Lung Liu, Taichung City (TW)

(72) Inventor: Yung-Lung Liu, Taichung City (TW)

(21) Appl. No.: 16/871,377

(22) Filed: May 11, 2020

(51) Int. Cl. G06F 3/02; G10L 21/0208; H04R 3/00

(52) U.S. Cl. CPC G06F 3/0219; G10L 2021/02163; H04R 3/002; G10L 21/0208

(57) ABSTRACT

A noise-cancelling keyboard includes a frame; keys on the frame; a microphone on an underside of the frame and configured to convert noise generated by pressing the keys into an electrical noise signal; a noise reduction device on the underside of the frame and electrically connected to the microphone, the noise reduction device being configured to generate an inverse noise signal combining with the electrical noise signal to form a new sound wave with the noise being substantially canceled; a loudspeaker on the underside of the frame and electrically connected to the noise reduction device, the loudspeaker being configured to convert an electrical audio signal representing the new sound wave into a corresponding sound; and a switch on a top of the frame and electrically interconnected to the noise reduction device and a power supply, the switch being configured to activate or deactivate the noise reduction device.

### BACKGROUND OF THE INVENTION

### 1. Field of the Invention

The invention relates to Active Noise Cancellation (ANC) and more particularly to a noise-cancelling keyboard having improved noise reduction characteristics.

### 2. Description of Related Art

Computer keyboard is a typewriter-style device which uses an arrangement of buttons or keys. Typewriter-style keyboards became the main input method for computers (e.g., personal computers, tablet computers, laptops, etc.). Keyboard keys typically have characters printed on them, and each press of a key typically corresponds to a single written symbol.

However, acoustic noise may be generated when a key is pressed. Such noise is unpleasant, loud or disruptive to hearing especially in the night or the quiet environment.

Thus, the need for improvement still exists.

### SUMMARY OF THE INVENTION

The invention has been made in an effort to solve the problems of the conventional keyboard including acoustic noise by providing a noise-cancelling keyboard having novel and nonobvious characteristics.

To achieve above and other objects of the invention, the invention provides a noise-cancelling keyboard comprising a frame; a plurality of keys disposed on the frame; a microphone disposed on an underside of the frame and configured to convert noise generated by pressing the keys into an electrical noise signal; a noise reduction device disposed on the underside of the frame and electrically connected to the microphone, the noise reduction device being configured to generate an inverse noise signal combining with the electrical noise signal to form a new sound wave with the noise being substantially canceled; a loudspeaker disposed on the underside of the frame and electrically connected to the noise reduction device, the loudspeaker being configured to convert an electrical audio signal representing the new sound wave into a corresponding sound; and a switch disposed on a top of the frame and electrically interconnected to the noise reduction device and a power supply, the switch being configured to activate the noise reduction device or deactivate the noise reduction device.

The above and other objects, features and advantages of the invention will become apparent from the following detailed description taken with the accompanying drawings.

### BRIEF DESCRIPTION OF THE DRAWINGS

FIG. 1 is a perspective view of a noise-cancelling keyboard according to the invention;

FIG. 2 is a schematic longitudinal sectional view of the noise-cancelling keyboard;

FIG. 3 is a view similar to FIG. 2 showing noise being generated by pressing a key; and

FIG. 4 is a block diagram of the noise-cancelling keyboard.

### DETAILED DESCRIPTION OF THE INVENTION

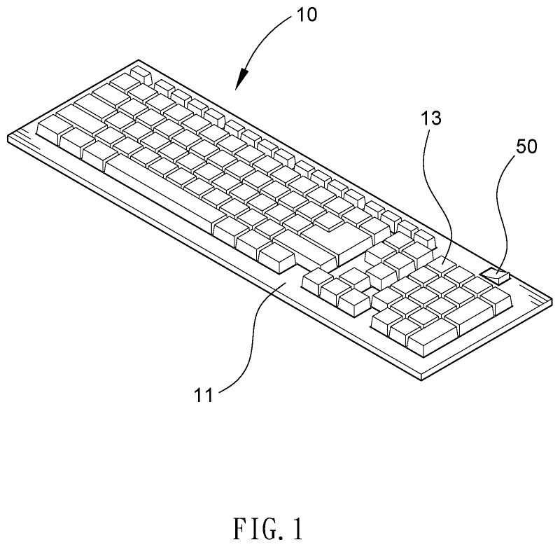

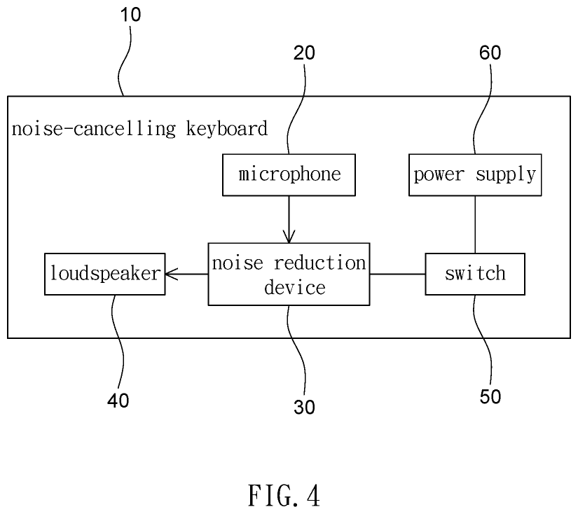

Referring to FIGS. 1 to 4, a noise-cancelling keyboard 10 in accordance with the invention comprises a microphone 20, a noise reduction device 30, a loudspeaker 40 and a switch 50 as discussed in detail below.

The keyboard 10 includes a frame 11, a plurality of keys (not numbered) provided on the frame 11 and each including a bridge structure 12 and a key cap 13 pivotably provided on the bridge structure 12. Alternatively, the keys are replaced by conventional elastic dome-shaped key caps. The microphone 20, the noise reduction device 30 and the loudspeaker 40 are provided on an underside of the frame 11, and the switch 50 is provided on a top of the frame 11.

The microphone 20 is a transducer that converts sound (i.e., noise) into an electrical signal representing noise generated by pressing key caps 13 and the electrical noise signal is sent to the noise reduction device 30 for sound wave analysis.

The noise reduction device 30 is electrically connected to the microphone 20, the loudspeaker 40 and the switch 50 respectively. The noise reduction device 30 includes a noise reduction processor and an ANC integrated circuit (IC) for filtering the low frequency noise signal received from the microphone 20 and generating an inverse noise signal combining with the noise signal to form a new sound wave with the noise being substantially canceled in a process called destructive interference.

The loudspeaker 40 is implemented as a membrane loudspeaker. The loudspeaker 40, as an electroacoustic transducer, is used to convert an electrical audio signal (i.e., representing the new sound wave) into a corresponding sound with noise being greatly reduced.

The switch 50 is used to control an on or off of the noise reduction device 30. Thus, a user may turn on the switch 50 to enable the ANC mode of the keyboard 10 or turn off the switch 50 to disable an ANC mode of the keyboard 10.

The switch 50 is electrically connected to a power supply 60 such as a power supply of a personal computer or a rechargeable battery of a wireless keyboard. For operating the keyboard 10 in the ANC mode, a user may turn on the switch 50 so that power may be supplied to the noise reduction device 30 for carrying out ANC. To the contrary, for operating the keyboard 10 in a non-ANC mode, a user may turn off the switch 50 so that power is stopped from supplying to the noise reduction device 30.

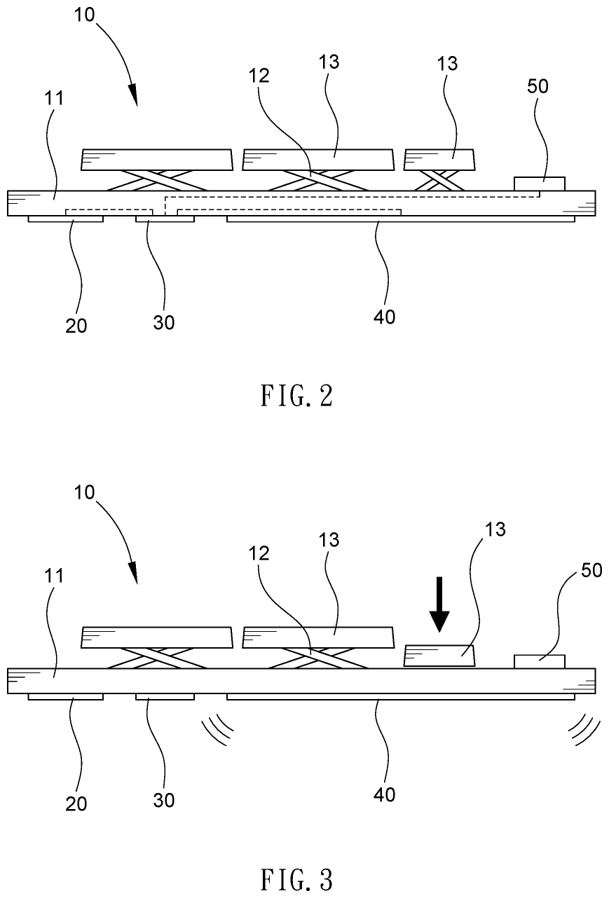

As shown in FIGS. 2 and 3, the microphone 20, the noise reduction device 30 and the loudspeaker 40 are flat, thin and provided on the underside of the frame 11. Thus, they do not interfere with the pressing of the key caps 13.

The provision of the switch 50 on the top of the keyboard 10 facilitates the on or off of the noise reduction device 30 by pressing the switch 50. For example, for operating in the night or quiet environment, a user may turn on the switch 50 to activate the noise reduction device 30 (i.e., operating in the ANC mode) so that noise generated by pressing the key caps 13 is substantially reduced.

While the invention has been described in terms of preferred embodiments, those skilled in the art will recognize that the invention can be practiced with modifications within the spirit and scope of the appended claims.

What is claimed is:

1. A noise-cancelling keyboard, comprising:
a frame;
a plurality of keys disposed on the frame;
a microphone disposed on an underside of the frame and configured to convert noise generated by pressing the keys into an electrical noise signal;
a noise reduction device disposed on the underside of the frame and electrically connected to the microphone, the noise reduction device being configured to generate an inverse noise signal combining with the electrical noise signal to form a new sound wave with the noise being substantially canceled;
a loudspeaker disposed on the underside of the frame and electrically connected to the noise reduction device, the loudspeaker being configured to convert an electrical audio signal representing the new sound wave into a corresponding sound; and
a switch disposed on a top of the frame and electrically interconnected to the noise reduction device and a power supply, the switch being configured to activate the noise reduction device or deactivate the noise reduction device.

2. The noise-cancelling keyboard of claim 1, wherein the noise reduction device includes a noise reduction processor and an ANC IC.

3. The noise-cancelling keyboard of claim 1, wherein the loudspeaker is implemented as a membrane loudspeaker.

4. The noise-cancelling keyboard of claim 1, wherein each of the keys includes a bridge structure and a key cap pivotably disposed on the bridge structure.

5. The noise-cancelling keyboard of claim 1, wherein the keys are elastic dome-shaped key caps.
